(19) United States
(12) Patent Application Publication
(10) Pub. No.: US 2025/0210794 A1
(43) Pub. Date: Jun. 26, 2025

(54) ENERGY STORAGE APPARATUS

(71) Applicant: GS Yuasa International Ltd., Kyoto-shi, Kyoto (JP)

(72) Inventors: Masayuki SHINTAKU, Kyoto (JP); Haruhiko MIZUTA, Kyoto (JP)

(21) Appl. No.: 18/729,050

(22) PCT Filed: Jan. 12, 2023
(86) PCT No.: PCT/JP2023/000574

§ 371 Date: Dec. 20, 2024

(30) Foreign Application Priority Data
Jan. 17, 2022 (JP) 2022-005093

(51) Int. Cl. H01M 50/333

(52) U.S. Cl. CPC H01M 50/333; H01M 2200/20

(57) ABSTRACT

An energy storage apparatus 1 includes a plurality of energy storage devices 20, an exhaust portion 71 which is arranged on a gas release valve 29 of each of a plurality of the energy storage devices 20 and forms an exhaust path 76 of gas, a plurality of manifold portions 31 that causes the gas release valve 29 of each of a plurality of the energy storage devices 20 to communicate with the exhaust path 76 of the exhaust portion 71, and a plurality of valve units 40 that close each of a plurality of the manifold portions 31. The valve unit 40 includes a lid body 41 of a single-hinged type that closes the manifold portion 31 and includes an open end portion 414 and a base end portion 413 which is an end portion on an opposite side to the open end portion 414, the lid body 41 having open width of the open end portion 414 larger than open width of the base end portion 413, and a flow regulating portion 42 arranged on a main surface (lower surface 419) facing the gas release valve 29 of the lid body 41 and extending in a direction intersecting a direction from the base end portion 413 toward the open end portion 414.

### TECHNICAL FIELD

The present invention relates to an energy storage apparatus.

### BACKGROUND ART

Conventionally, in an energy storage apparatus, an exhaust portion (upper plate) is attached to a plurality of energy storage devices (secondary batteries) arranged in a predetermined direction (see, for example, Patent Document 1). When the energy storage device is damaged or the like and enters an overheated state due to use not in a normally expected use form or use state, or the like, pressure in each energy storage device increases, and gas having high temperature is released from a gas release valve (vent). The exhaust portion is a member which forms an exhaust path of gas discharged from each energy storage device, and gas is discharged to the outside of the energy storage apparatus from a tip portion of the exhaust path. A plurality of manifolds (opening portions) for introducing gas discharged from a gas release valve of each energy storage device into the exhaust portion are formed in the exhaust portion.

### PRIOR ART DOCUMENT

### Patent Document

Patent Document 1: JP-A-2011-108653

### SUMMARY OF THE INVENTION

### Problems to be Solved by the Invention

When high-temperature gas discharged from one energy storage device is introduced into an exhaust portion through a manifold, the high-temperature gas may come into contact with another energy storage device from another manifold. When discharged from an energy storage device, high-temperature gas is sometimes discharged together with electrolyte solution which is a combustible substance or a high-temperature object (high-temperature active material and current collecting foil), and these may adversely affect another energy storage device.

An object of the present invention is to prevent an adverse effect on another energy storage device when high-temperature gas is discharged from an energy storage device.

### Means for Solving the Problems

In order to achieve the above object, an energy storage apparatus according to an aspect of the present invention includes a plurality of energy storage devices each of which includes a gas release valve and which are arranged in a posture in which the gas release valves face a same direction, an exhaust portion arranged on the gas release valve of each of a plurality of the energy storage devices and forming an exhaust path of gas discharged from the gas release valve, a plurality of manifold portions causing the gas release valve of each of a plurality of the energy storage devices to communicate with the exhaust path of the exhaust portion, and a plurality of valve units that close each of a plurality of the manifold portions. The valve unit includes a lid body of a single-hinged type that closes the manifold portion and includes an open end portion and a base end portion which is an end portion on an opposite side to the open end portion, the lid body having open width of the open end portion larger than open width of the base end portion, and a flow regulating portion that is arranged on a main surface facing the gas release valve of the lid body and extends in a direction intersecting a direction from the base end portion toward the open end portion.

### Advantages of the Invention

According to the energy storage apparatus of the present invention, if high-temperature gas is discharged from an energy storage device, an adverse effect on another energy storage device can be prevented.

### BRIEF DESCRIPTION OF THE DRAWINGS

FIG. 1 is a perspective view illustrating an external appearance of an energy storage apparatus according to an embodiment.

FIG. 2 is an exploded perspective view illustrating each constituent element in a case where the energy storage apparatus according to the embodiment is disassembled.

FIG. 3 is a perspective view illustrating an external appearance of an energy storage device according to the embodiment.

FIG. 4 is an exploded perspective view of an opening and closing unit according to the embodiment.

FIG. 5 is a perspective view of a valve unit according to the embodiment as viewed from a Z-axis plus direction.

FIG. 6 is a perspective view of the valve unit according to the embodiment as viewed from a Z-axis minus direction.

FIG. 7 is a side view of the valve unit in a closed state according to the embodiment as viewed from a Y-axis minus direction.

FIG. 8 is a side view of the valve unit in an open state according to the embodiment as viewed from the Y-axis minus direction.

FIG. 9 is a side view of the valve unit according to a first modification example as viewed from the Y-axis minus direction.

FIG. 10 is a side view of the valve unit according to a second modification example as viewed from the Y-axis minus direction.

### MODE FOR CARRYING OUT THE INVENTION

[1]: An energy storage apparatus according to an aspect of the present invention includes a plurality of energy storage devices each of which includes a gas release valve and which are arranged in a posture in which the gas release valves face a same direction, an exhaust portion arranged on the gas release valve of each of a plurality of the energy storage devices and forming an exhaust path of gas discharged from the gas release valve, a plurality of manifold portions causing the gas release valve of each of a plurality of the energy storage devices to communicate with the exhaust path of the exhaust portion, and a plurality of valve units that close each of a plurality of the manifold portions. The valve unit includes a lid body of a single-hinged type that closes the manifold portion and includes an open end portion and a base end portion which is an end portion on an opposite side to the open end portion, the lid body having open width of the open end portion larger than open width of the base end portion, and a flow regulating portion that is arranged on a main surface facing the gas release valve of the lid body and extends in a direction intersecting a direction from the base end portion toward the open end portion.

According to the energy storage apparatus described in [1] above, in the lid body of a single-hinged type which closes the manifold portion, the flow regulating portion which extends in a direction intersecting a direction from the base end portion toward the open end portion is provided on the main surface, so that flow of gas from the base end portion toward the open end portion can be regulated by the flow regulating portion. Specifically, when the lid body is opened by gas discharged from the gas release valve, a part of the gas flows along the main surface of the lid body and reaches the flow regulating portion. Since flow of gas can be regulated by the flow regulating portion, it is possible to prevent gas from being caught in a direction opposite to a direction in which the gas is desired to be exhausted. By the above, it is possible to cause gas to smoothly flow in a direction in which the gas is desired to be exhausted, and it is possible to prevent a combustible substance (electrolyte solution), a high-temperature object (high-temperature active material and current collecting foil), and the like which may be discharged together with the gas from coming into contact with another energy storage device. Accordingly, if high-temperature gas is discharged from the energy storage device, an adverse effect on another energy storage device can be prevented.

[2]: In the energy storage apparatus according to [1] above, in the flow regulating portion, a surface exposed to gas may be a curved surface projecting toward at least one of the lid body and the gas release valve.

According to the energy storage apparatus described in [2] above, in the flow regulating portion, a surface exposed to gas is a curved surface that projects toward at least one of the lid body and the gas release valve, so that gas can be regulated by a smooth curved surface, and a flow regulating effect can be further enhanced. When a flow regulating effect is enhanced, it is possible to further prevent a combustible substance, a high-temperature object, and the like from coming into contact with another energy storage device, and it is possible to further prevent an adverse effect on another energy storage device.

[3]: In the energy storage apparatus according to [1] or [2], at least one of one end portion and another end portion in a direction from the base end portion toward the open end portion may have a tapered shape in the flow regulating portion.

For example, when there is a corner portion in the flow regulating portion, there is a high possibility that gas is disturbed. However, according to the energy storage apparatus described in [3] above, when at least one of one end portion and another end portion of the flow regulating portion has a tapered shape, at least one of the one end portion and the another end portion can be formed in a streamlined shape. For this reason, it is possible to make it difficult to generate a turbulent flow in flow of gas, and it is possible to further enhance a flow regulating effect. When a flow regulating effect is enhanced, it is possible to more reliably prevent a combustible substance, a high-temperature object, and the like from coming into contact with another energy storage device, and thus, it is possible to further prevent an adverse effect on another energy storage device.

[4]: In the energy storage apparatus according to [3] above, the flow regulating portion may be arranged at a predetermined interval with respect to the lid body.

According to the energy storage apparatus described in [4], since the flow regulating portion is arranged at a predetermined interval with respect to the lid body, a part of gas flows also within the interval. In gas flowing through this interval, a flow regulating effect of the flow regulating portion can be more reliably exhibited, so that flow regulation of gas can be stabilized.

[5]: In the energy storage apparatus according to [3] or [4] above, the flow regulating portion may be rotatably supported by the lid body.

According to the energy storage apparatus described in [5] above, since the flow regulating portion is rotatably supported by the lid body, a posture of the flow regulating portion can be displaced along flow of gas by being rotated. By the above, the flow regulating portion can be prevented from inhibiting flow of gas, and a flow regulating effect can be stably exhibited.

[6]: In the energy storage apparatus according to any one of [1] to [5] above, in the lid body, the base end portion may be rotatably supported with respect to the manifold portion.

According to the energy storage apparatus described in [6] above, since the base end portion of the lid body is rotatably supported by the manifold portion, opening operation and closing operation of the lid body can be smoothly performed. For example, since the manifold portion can be closed by the lid body after gas is discharged, gas in an exhaust path hardly flows into the gas release valve that is opened. For this reason, it is possible to further prevent the energy storage device from being excessively heated after gas is discharged.

### Embodiment

Hereinafter, an energy storage apparatus according to an embodiment of the present invention will be described with reference to the drawings. Note that all embodiments described below illustrate a comprehensive or specific example. Numerical values, shapes, materials, constituent elements, arrangement positions and connection modes of the constituent elements, and the like shown in the embodiments below are merely examples, and are not intended to limit the present invention. Further, in the drawings, dimensions and the like are not strictly illustrated.

Further, description and drawings below, an arrangement direction of energy storage devices, a facing direction of long side surfaces of a case of an energy storage device, or a thickness direction of the case is defined as an X-axis direction. Further, an arrangement direction of electrode terminals in one energy storage device or a facing direction of short side surfaces of a case of an energy storage device is defined as a Y-axis direction. Further, an arrangement direction of a body portion and an outer lid of an outer case of an energy storage apparatus, or a vertical direction is defined as a Z-axis direction. The Z-axis direction is also an insertion direction when a plurality of energy storage devices are inserted into a body opening portion of the body portion. The X-axis direction, the Y-axis direction, and the Z-axis direction are directions intersecting (in an embodiment below, orthogonal to) each other. Note that, although a case where the Z-axis direction is not the vertical direction can be considered depending on a usage mode, the Z-axis direction will be described below as the vertical direction for convenience of description. Further, in description below, for example, the X-axis direction plus side indicates the arrow direction side of the X axis, and the X-axis minus side indicates the side opposite to the X-axis direction plus side. The same applies to the Y-axis direction and the Z-axis direction. Furthermore, expressions indicating a relative direction or postures, such as parallel and orthogonal, include a case where the direction or posture is not strictly expressed. For example, that two directions are orthogonal to each other not only means that the two directions are completely orthogonal to each other, but also means that the two directions are substantially orthogonal to each other, that is, a difference of, for example, about several percent is included.

### General Description of Energy Storage Apparatus

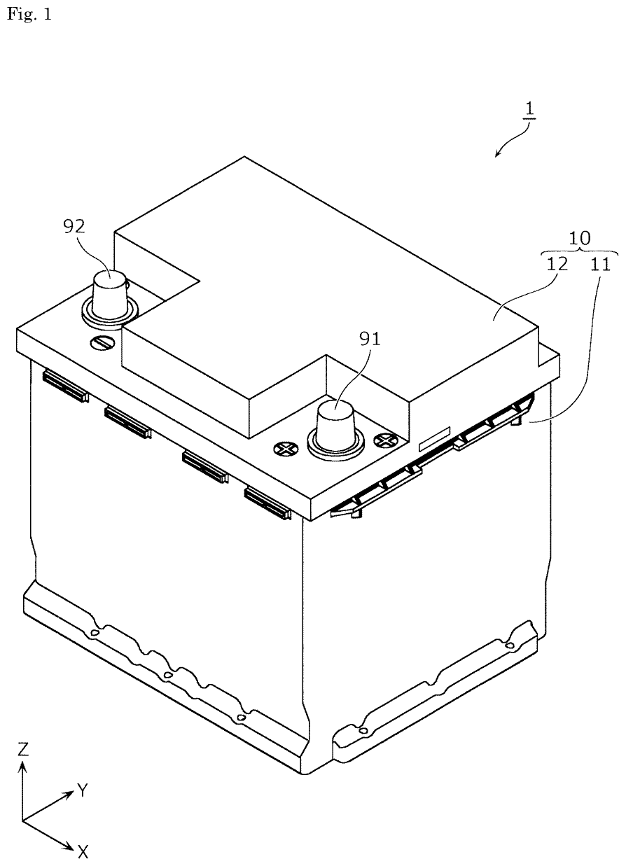

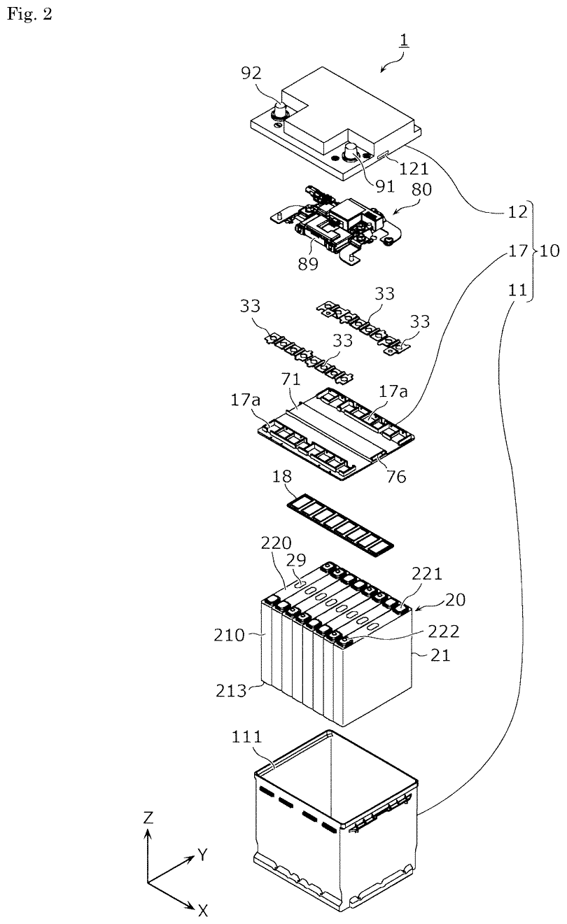

First, an energy storage apparatus 1 according to an embodiment will be generally described with reference to FIGS. 1 and 2. FIG. 1 is a perspective view illustrating an external appearance of the energy storage apparatus 1 according to the embodiment. FIG. 2 is an exploded perspective view illustrating each constituent element in a case where the energy storage apparatus 1 according to the embodiment is disassembled.

The energy storage apparatus 1 is an apparatus capable of being charged with electricity from the outside and discharging electricity to the outside, and has a substantially rectangular parallelepiped shape in the present embodiment. For example, the energy storage apparatus 1 is a battery module (assembled battery) used for energy storage application, power supply application, or the like. Specifically, for example, the energy storage apparatus 1 is used as a battery or the like for driving or starting an engine of a moving body such as an automobile, a motorcycle, a watercraft, a ship, a snowmobile, an agricultural machine, a construction machine, or a railway vehicle for an electric railway. Examples of the automobile include an electric vehicle (EV), a hybrid electric vehicle (HEV), a plug-in hybrid electric vehicle (PHEV), and an automobile of fossil fuel (gasoline, light oil, liquefied natural gas, or the like). Examples of the railway vehicle for an electric railway include a train, a monorail, a linear motor car, and a hybrid train including both a diesel engine and an electric motor. The energy storage apparatus 1 can also be used as a stationary battery or the like used for home use, commercial use, or the like.

As illustrated in FIG. 1 and FIG. 2, the energy storage apparatus 1 includes an energy storage device 20 and an outer case 10 which houses a plurality of the energy storage devices 20. The outer case 10 includes a body portion 11 which houses a plurality of the energy storage devices 20, a bus bar frame 17 which is arranged above a plurality of the energy storage devices 20, an opening and closing unit 18 which is interposed between the bus bar frame 17 and a plurality of the energy storage devices 20, and an outer lid 12 which covers an upper portion of the bus bar frame 17.

The outer case 10 is a case (module case) having a rectangular shape (box shape) which structures an outer case of the energy storage apparatus 1. That is, the outer case 10 is a member which fixes a plurality of the energy storage devices 20, the bus bar frame 17, and the like at predetermined positions and protects these elements from an impact or the like.

The body portion 11 is a bottomed rectangular cylindrical member whose upper portion is opened, and the opened portion is a body opening portion 111. The body opening portion 111 has a substantially rectangular shape in plan view. In addition to a plurality of the energy storage devices 20 and the bus bar frame 17, a plurality of bus bars 33 held by the bus bar frame 17 and a connection unit 80 including a control circuit and the like are housed in the body opening portion 111 of the body portion 11. Note that, although not illustrated, a pair of end plates which sandwich a plurality of the energy storage devices 20 in an X-axis direction, an intermediate spacer arranged between each of the energy storage devices 20, and the like may be housed in the body opening portion 111.

The outer lid 12 is a rectangular member that closes the body opening portion 111 of the body portion 11. The outer lid 12 is joined to the body portion 11 in a state of covering the body opening portion 111 of the body portion 11. The outer lid 12 has an external terminal 91 of a positive electrode and an external terminal 92 of a negative electrode. The external terminals 91 and 92 are electrically connected to a plurality of the energy storage devices 20 via the connection unit 80 and the bus bar 33, and the energy storage apparatus 1 is charged with electricity from the outside and discharges electricity to the outside via the external terminals 91 and 92. The external terminals 91 and 92 are formed of, for example, a conductive member made from metal such as a copper alloy such as brass, copper, aluminum, and an aluminum alloy.

An exhaust port 121 is formed in a wall portion in an X-axis plus direction of the outer lid 12. The exhaust port 121 is covered with a ventilation waterproof film (not illustrated), and can exhaust gas from the inside to the outside while preventing water from entering from the outside.

Further, the body portion 11 and the outer lid 12 of the outer case 10 is formed of an insulating member such as polycarbonate (PC), polypropylene (PP), polyethylene (PE), polystyrene (PS), polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene-perfluoroalkyl vinyl ether (PFA), polytetrafluoroethylene (PTFE), polyether sulfone (PES), ABS resin, or a composite material of these, or insulation-coated metal. By the above, the outer case 10 prevents the energy storage device 20 and the like from coming into contact with a metal member of the outside or the like. Note that the outer case 10 may be formed of a conductive member of metal or the like as long as electric insulation property of the energy storage device 20 and the like is maintained.

The energy storage device 20 is a secondary battery (battery cell) capable of being charged with electricity and discharging electricity, and more specifically, is a nonaqueous electrolyte secondary battery such as a lithium ion secondary battery. The energy storage device 20 has a flat rectangular parallelepiped shape (prismatic shape), and in the present embodiment, eight of the energy storage devices 20 are arranged in the X-axis direction. Note that a shape of the energy storage device 20 and the number of the energy storage devices 20 to be arranged are not limited. Further, the energy storage device 20 is not limited to a nonaqueous electrolyte secondary battery, and may be a secondary battery other than a nonaqueous electrolyte secondary battery, may be a capacitor, or may be a primary battery that can use stored electricity without being charged by the user. The energy storage device 20 may be a solid electrolyte battery. The energy storage device 20 may be a pouch type energy storage device in which a case 21 is formed of a metal resin composite film.

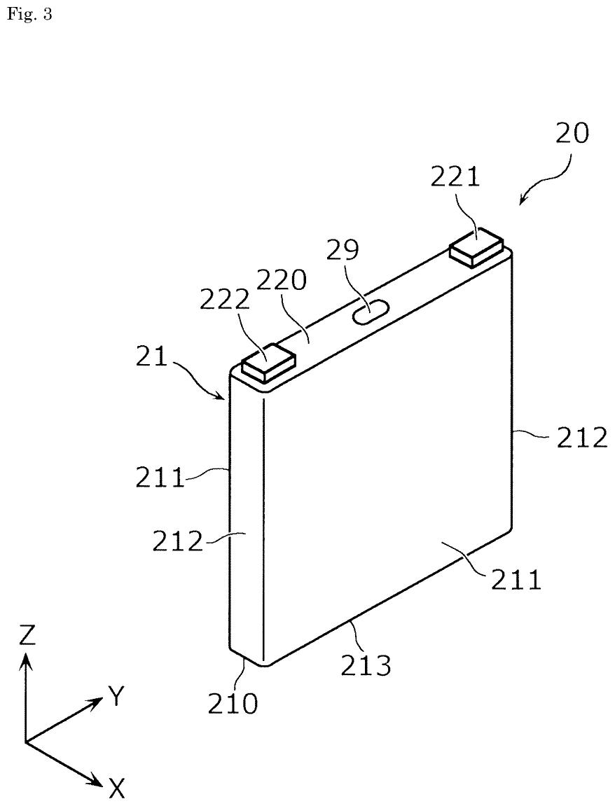

FIG. 3 is a perspective view illustrating an external appearance of the energy storage device 20 according to the embodiment. As illustrated in FIG. 3, the energy storage device 20 includes the case 21 and a pair of electrode terminals (positive electrode terminal 221 and negative electrode terminal 222). Further, although an electrode assembly, a pair of current collectors (of a positive electrode and a negative electrode), electrolyte solution (nonaqueous electrolyte), and the like are housed in the case 21, these are not illustrated. A kind of the electrolyte solution is not particularly limited as long as the electrolyte solution does not impair performance of the energy storage device 20, and various kinds of electrolyte solution can be selected. Further, a gasket or the like is arranged between the case 21 and a pair of electrode terminals and a pair of current collectors in order to enhance insulation and airtightness, but these are not illustrated either. Further, in addition to the above constituent element, a spacer arranged on the side or below the electrode assembly, an insulating film enclosing the electrode assembly or the like, or the like may be arranged.

The case 21 is a case having a rectangular parallelepiped shape (prismatic or box shape) including a case body 210 in which an opening is formed and a lid plate 220 that closes the opening of the case body 210. With such a configuration, the case 21 has a structure in which the inside can be sealed by joining the case body 210 and the lid plate 220 to each other by welding or the like after an electrode assembly and the like are housed in the inside of the case body 210. A material of the case 21 is not particularly limited, but is preferably weldable metal such as stainless steel, aluminum, an aluminum alloy, iron, or a plated steel plate.

The case body 210 is a member including a bottom and a rectangular cylindrical shape structuring a body portion of the case 21, and has an opening formed on the plus side in the Z-axis direction. That is, as illustrated in FIG. 3, the case body 210 has a pair of long side surfaces 211 on both side surfaces in the X-axis direction, a pair of short side surfaces 212 on both side surfaces in the Y-axis direction, and a bottom surface 213 on the minus side in the Z-axis direction.

The lid plate 220 is a rectangular plate-like member which structures a lid portion of the case 21 and is elongated in the Y-axis direction, and is arranged on the plus side in the Z-axis direction of the case body 210. The lid plate 220 may be provided with an electrolyte solution filling unit for filling with electrolyte solution, a gas release valve 29 for releasing pressure by discharging gas when pressure in the case 21 rises, and the like. The gas release valve 29 is arranged at an intermediate portion in a longitudinal direction (Y-axis direction) of the lid plate 220.

The positive electrode terminal 221 and the negative electrode terminal 222 are provided on the lid plate 220. Specifically, the positive electrode terminal 221 and the negative electrode terminal 222 are electrode terminals arranged so as to protrude from the lid plate 220 of the case 21 toward the bus bar frame 17 (upward, that is, toward the plus side in the Z-axis direction). As the positive electrode terminal 221 and the negative electrode terminal 222 are connected to the external terminals 91 and 92 via at least one of the bus bars 33 and the connection unit 80, the energy storage apparatus 1 can be charged with electricity from the outside and discharge electricity to the outside. The positive electrode terminal 221 is formed of a conductive member of metal such as aluminum or an aluminum alloy, and the negative electrode terminal 222 is formed of a conductive member of metal such as copper or a copper alloy.

The electrode assembly is an energy storage element (power generating element) formed by stacking a positive electrode plate, a negative electrode plate, and a separator. The positive electrode plate includes a positive active material layer formed on a positive electrode substrate layer which is current collecting foil made from metal such as aluminum or an aluminum alloy. The negative electrode plate includes a negative active material layer formed on a negative electrode substrate layer which is current collecting foil made from metal such as copper or a copper alloy. As an active material used for the positive active material layer and the negative active material layer, a publicly-known material can be appropriately used as long as the material can occlude and discharge lithium ions. Note that the electrode assembly may be an electrode assembly of any form such as a wound electrode assembly formed by winding a positive electrode plate and a negative electrode plate stacked with a separator interposed between them, a stacked (stack type) electrode assembly formed by stacking a plurality of flat plate-shaped positive electrode plates and negative electrode plates with a separator interposed between them, or a bellows electrode assembly formed by folding a positive electrode plate and a negative electrode plate stacked with a separator interposed between them in a bellows shape.

The current collector is a member (a positive electrode current collector and a negative electrode current collector) having conductivity and rigidity for electrically connecting electrode terminals (the positive electrode terminal 221 and the negative electrode terminal 222) and the electrode assembly. The positive electrode current collector is made from aluminum, an aluminum alloy or the like similarly to the positive electrode substrate layer of the positive electrode plate, and the negative electrode current collector is made from copper, a copper alloy or the like similarly to the negative electrode substrate layer of the negative electrode plate.

As illustrated in FIG. 2, the bus bar 33 is a rectangular plate-like member which is arranged on at least two of the energy storage devices 20 in a state where the bus bar 33 is held by the bus bar frame 17 and electrically connects electrode terminals (the positive electrode terminal 221 and the negative electrode terminal 222) of the at least two energy storage devices 20. The bus bar 33 is formed of, for example, a conductive member made from metal such as copper, a copper alloy, aluminum, an aluminum alloy, nickel, or a clad material. Note that, in the present embodiment, by using five of the bus bars 33, two of the energy storage devices 20 are connected in parallel to form four sets of energy storage device groups, and the four sets of energy storage device groups are connected in series.

The connection unit 80 is a unit including a plurality of bus bars, a control board, and the like, and connects an energy storage device group including eight of the energy storage devices 20 and the external terminals 91 and 92. The control board included in the connection unit 80 includes a plurality of electric components, and a detection circuit that detects a state of each of the energy storage devices 20, a control circuit that controls charge and discharge, and the like are formed by a plurality of the electric components. The connection unit 80 is provided with a connector portion 89 of the detection circuit or the control circuit. In the present embodiment, the connection unit 80 is fixed to the bus bar frame 17. The detection circuit and the control circuit may be formed on separate control boards. The connection unit 80 does not need to include a control board. In this case, for example, a control device arranged outside the energy storage apparatus 1 may control charge and discharge of each of the energy storage devices 20. Further, a sensor attached to the energy storage device 20 is electrically connected to the detection circuit. Here, examples of the sensor include a temperature sensor (thermistor) that detects temperature of the energy storage device 20, a voltage sensor that detects voltage of the energy storage device 20, and the like.

The bus bar frame 17 is a member arranged above a plurality of the energy storage devices 20 (on the side where an electrode terminal is arranged), and forms an exhaust path 76 (described later) of gas discharged from the gas release valve 29 of each of the energy storage devices 20.

In the present embodiment, the bus bar frame 17 is a member which holds the bus bar 33 and a sensor mounted on the energy storage device 20. More specifically, the bus bar frame 17 is a member that holds a plurality of the bus bars 33, the connection unit 80, a sensor, and other wirings and the like (not illustrated), and can perform position restriction and the like of these members. Further, the bus bar frame 17 is provided with a plurality of bus bar opening portions 17a which hold each of a plurality of the bus bars 33 and expose a part of a plurality of the bus bars 33 toward a plurality of the energy storage devices 20. Further, by being fixed to the body portion 11, the bus bar frame 17 also plays a role of restricting movement toward the upper side (toward the plus side in the Z-axis direction) of a plurality of the energy storage devices 20, for example.

A plurality of the bus bar opening portions 17a are arranged at both end portions in the Y-axis direction of the bus bar frame 17, and are arranged along the X-axis direction. On the other hand, an exhaust portion 71 extending in the X-axis direction is formed in an intermediate portion in the Y-axis direction of the bus bar frame 17. The exhaust portion 71 is a portion protruding in the Z-axis plus direction, and the exhaust path 76 opened downward is formed on a lower surface (a surface in the Z-axis minus direction) of the exhaust portion 71. The exhaust path 76 extends over an entire length in the X-axis direction of the exhaust portion 71. The exhaust path 76 is a path for guiding gas discharged from the gas release valve 29 of each of the energy storage devices 20. An end portion in the X-axis plus direction of the exhaust path 76 is opened, and the opened portion is connected to the exhaust port 121 of the outer lid 12. That is, gas passes through the exhaust path 76 is discharged from the exhaust port 121 to the outside of the outer lid 12.

The bus bar frame 17 is also referred to as, for example, a “bus bar plate”, an “inner lid”, or the like in some cases. The bus bar frame 17 is formed of, for example, an insulating member such as PC, PP, PE, PS, PPS, PPE (including modified PPE), PET, PBT, PEEK, PFA, PTFE, PES, ABS resin, or a composite material of these, or insulation-coated metal.

### Opening and Closing Unit

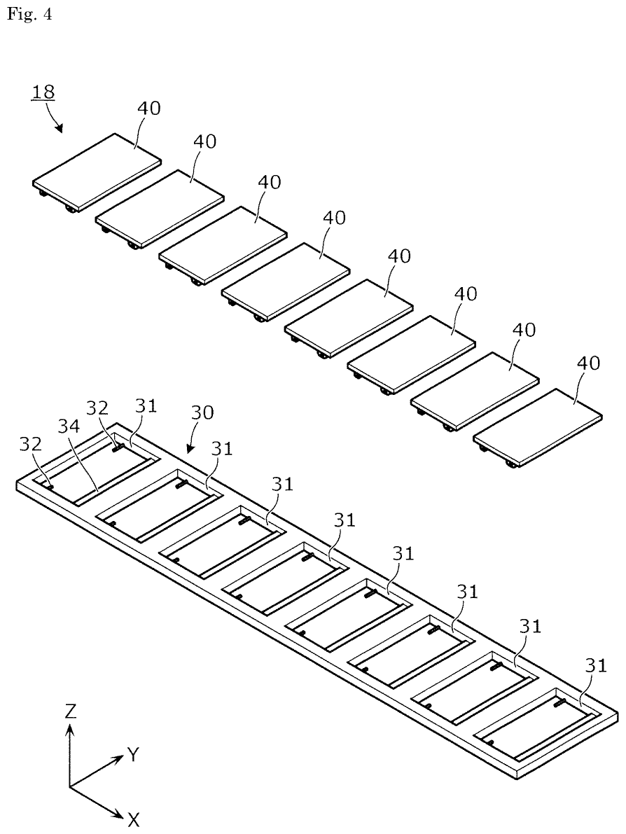

The opening and closing unit 18 is a portion that covers the lower side of the exhaust portion 71 to open and close between the gas release valve 29 of each of the energy storage devices 20 and the exhaust path 76. Hereinafter, the opening and closing unit 18 will be described in detail. FIG. 4 is an exploded perspective view of the opening and closing unit 18 according to the embodiment. As illustrated in FIG. 4, the opening and closing unit 18 includes a plate-shaped support plate 30 and a plurality of valve units 40.

The support plate 30 is a portion that supports each of the valve units 40 in an openable and closable manner. To be more specific, the support plate 30 is a plate body which is elongated in the X-axis direction, and an opened manifold portion 31 is formed at a place corresponding to the gas release valve 29 of each of the energy storage devices 20. The manifold portions 31 are provided as many as the total number of a plurality of the energy storage devices 20.

When the support plate 30 is placed on and brought into close contact with the lid plate 220 of a plurality of the energy storage devices 20, one of the gas release valves 29 is arranged in one of the manifold portions 31. Furthermore, when the bus bar frame 17 is placed on a plurality of the energy storage devices 20, the support plate 30 is fitted to a lower portion of the exhaust portion 71, and the exhaust path 76 is covered with the support plate 30. That is, each of the manifold portions 31 is a flow path connecting each of the gas release valves 29 and the exhaust path 76.

Specifically, the manifold portion 31 is an opening portion having a rectangular shape in a plan view (as viewed in the Z-axis direction) elongated in the Y-axis direction. On a pair of inner side surfaces facing each other in the Y-axis direction of the manifold portion 31, a pair of shaft bodies 32 rotatably supporting the valve unit 40 are provided at an end portion in the X-axis minus direction. On an inner side surface in the X-axis plus direction of the manifold portion 31, a beam portion 34 which supports the valve unit 40 in a closed state from below is provided.

The support plate 30 is formed of, for example, an insulating member such as PC, PP, PE, PS, PPS, PPE (including modified PPE), PET, PBT, PEEK, PFA, PTFE, PES, ABS resin, or a composite material of these, or insulation-coated metal.

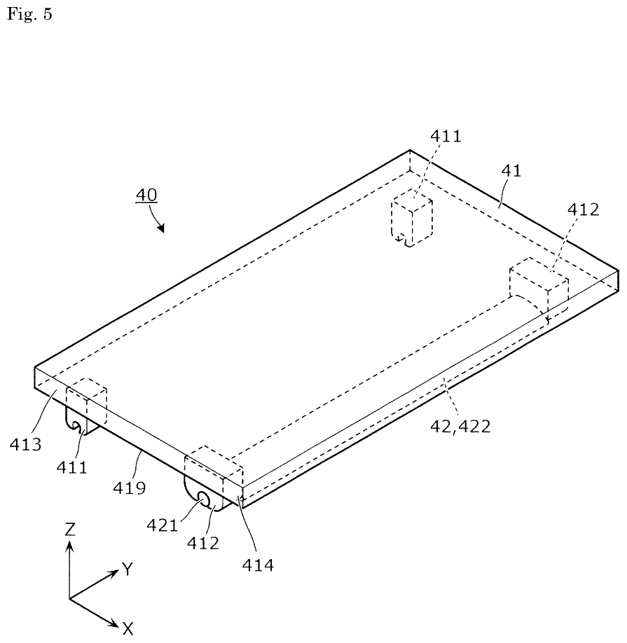

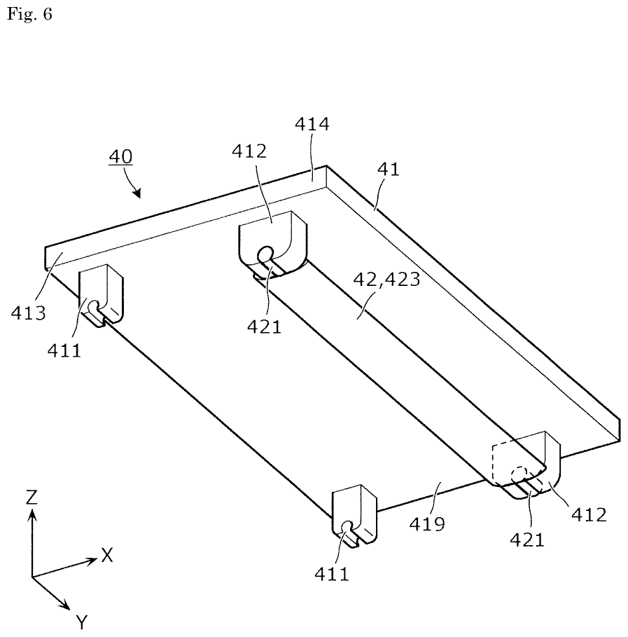

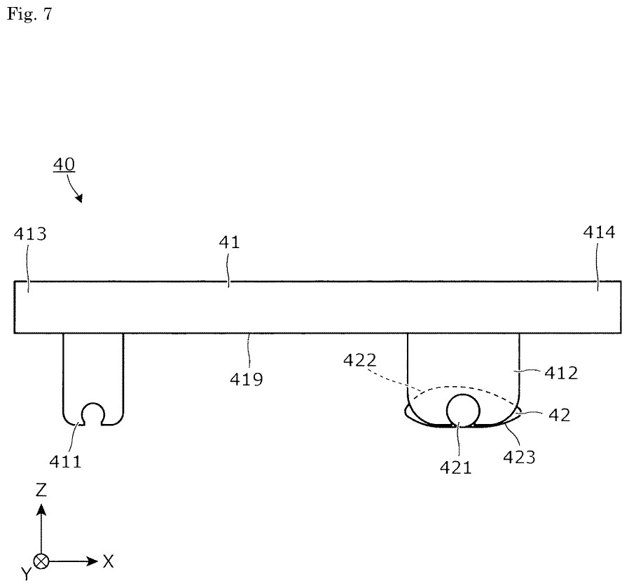

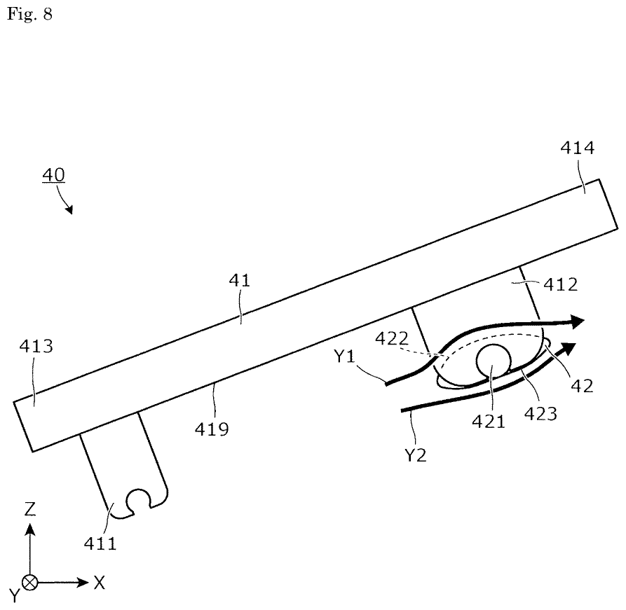

FIG. 5 is a perspective view of the valve unit 40 according to the embodiment as viewed from the Z-axis plus direction. FIG. 6 is a perspective view of the valve unit 40 according to the embodiment as viewed from the Z-axis minus direction. FIG. 7 is a side view of the valve unit 40 in a closed state according to the embodiment as viewed from the Y-axis minus direction. FIG. 8 is a side view of the valve unit 40 in an open state according to the embodiment as viewed from the Y-axis minus direction.

As illustrated in FIGS. 5 to 8, the valve unit 40 includes a lid body 41 and a flow regulating portion 42. The lid body 41 is formed in a shape capable of closing the manifold portion 31. To be more specific, the lid body 41 is a plate body having a rectangular shape as viewed in plan view (as viewed in the Z-axis direction) which is elongated in the Y-axis direction. A pair of first bearings 411 and a pair of second bearings 412 are provided on a lower surface 419 (a surface in the Z-axis minus direction) of the lid body 41. Here, the lower surface 419 of the lid body 41 is an example of a main surface facing the gas release valve 29.

A pair of the first bearings 411 are arranged at an end portion (base end portion) in the X-axis minus direction on the lower surface 419 of the lid body 41. Each of the first bearings 411 protrudes downward from the lower surface 419 of the lid body 41, and is a portion whose tip portion is rotatably engaged with a pair of the shaft bodies 32 of the manifold portion 31. That is, an end portion in the X-axis minus direction of the lid body 41 is a base end portion 413 which is substantially the center of rotation. As described above, the lid body 41 is a single-hinged type lid body.

In a state where the lid body 41 closes the manifold portion 31, the lid body 41 is in a state of covering the gas release valve 29 from above. For this reason, the lid body 41 receives gas discharged from the gas release valve 29. When the lid body 41 receives gas discharged from the gas release valve 29, as illustrated in FIG. 8, the lid body 41 rotates about the base end portion 413, and an end portion in the X-axis plus direction is opened. That is, the end portion in the X-axis plus direction of the lid body 41 is an open end portion 414. Open width of the open end portion 414 is larger than open width of the base end portion 413. Here, the open width is a movement amount when the lid body 41 is displaced from a closed state to an open state. That is, when the lid body 41 is displaced from the closed state to the open state, a movement amount of the open end portion 414 is larger than a movement amount of the base end portion 413.

A pair of the second bearings 412 are arranged at a position close to the open end portion 414 on the lower surface 419 of the lid body 41. Each of the second bearings 412 is a portion that protrudes downward from the lower surface 419 of the lid body 41 and rotatably supports the flow regulating portion 42.

The flow regulating portion 42 is indirectly arranged on the lower surface 419 of the lid body 41 by being supported by a pair of the second bearings 412. As illustrated in FIG. 6, the flow regulating portion 42 is a rod-shaped body extending in a direction (Y-axis direction) orthogonal to a direction (X-axis direction) from the base end portion 413 toward the open end portion 414. A shaft portion 421 is provided at both end portions in the Y-axis direction of the flow regulating portion 42. Each of the shaft portions 421 is rotatably supported by each of the second bearings 412. When each of the shaft portions 421 is supported by each of the second bearings 412, the flow regulating portion 42 is arranged at a predetermined interval with respect to the lower surface 419 of the lid body 41.

The flow regulating portion 42 has a uniform outer shape over an entire length in the Y-axis direction. Specifically, as illustrated in FIG. 7, each of one end portion and another end portion in the Y-axis direction of the flow regulating portion 42 has a tapered shape. Further, in the flow regulating portion 42, an upper surface 422 is a curved surface that projects toward the lid body 41, and the lower surface 423 is a curved surface that projects toward the gas release valve 29. As described above, the flow regulating portion 42 has a wing-like shape as viewed in the X-axis direction. That is, the flow regulating portion 42 has a shape in which upward lift is generated when exposed to gas flowing in the X-axis plus direction.

Each of the valve units 40 can be formed of the resin or metal described above, but the lid body 41 and the flow regulating portion 42 exposed to high-temperature gas are desirably formed of metal. In particular, the lid body 41 and the flow regulating portion 42 are preferably formed of metal having a melting point of 600° C. or more.

### Operation of Valve Unit

Next, operation of the valve unit 40 will be described. First, when each of the energy storage devices 20 is in a normally expected use form or use state, none of the gas release valves 29 is opened. For this reason, the valve unit 40 is also not affected by gas and is in a closed state as illustrated in FIG. 7. At this time, the open end portion 414 of the lid body 41 of the valve unit 40 is supported from below by the beam portion 34 (see FIG. 4) of the manifold portion 31.

When any of the energy storage devices 20 is damaged or the like and in an overheated state and pressure in the energy storage device 20 increases, the gas release valve 29 of the energy storage device 20 is opened, excessively high temperature gas is discharged, and the lid body 41 is rotated by the gas. By the above, the open end portion 414 moves more than the base end portion 413, and the valve unit 40 enters an open state as illustrated in FIG. 8. In the open state, the manifold portion 31 is opened, and the gas release valve 29 communicates with the exhaust path 76.

At this time, gas flows in a direction from the base end portion 413 toward the open end portion 414 along the lower surface 419 of the lid body 41. The gas is regulated when passing through the flow regulating portion 42. Due to this flow regulation effect, gas easily flows toward the exhaust port 121 in the exhaust path 76, and hardly flows to the side opposite to the exhaust port 121. By the above, it is possible to prevent a combustible substance (electrolyte solution), a high-temperature object (high-temperature active material and current collecting foil), or the like which may be discharged together with gas from coming into contact with another one of the energy storage devices 20 arranged further in the X-axis minus direction than the energy storage device 20 for which a valve is opened. Further, for another one of the energy storage devices 20 other than the energy storage device 20 for which a valve is opened, the valve unit 40 remains in a closed state. Accordingly, it is possible to prevent a combustible substance, a high-temperature object, and the like which may be discharged together with gas from coming into contact with another one of the energy storage device 20.

Here, gas is split by the flow regulating portion 42 and then merged. However, since one end portion and another end portion of the flow regulating portion 42 have a tapered shape, turbulence is less likely to occur at the time of splitting or merging. Therefore, a flow regulating effect can be further enhanced.

When gas is split by the flow regulating portion 42, a part of the gas flows along the upper surface 422 of the flow regulating portion 42 from between the flow regulating portion 42 and the lid body 41 (arrow Y1). Further, another part of the gas flows along the lower surface 423 of the flow regulating portion 42 (arrow Y2). By the above, since upward lift is generated in the flow regulating portion 42, the lid body 41 also rotates further upward. Furthermore, since the flow regulating portion 42 is rotatably supported by the lid body 41, a posture of the flow regulating portion 42 can be displaced along flow of gas by rotating. By the above, the flow regulating portion 42 can be prevented from inhibiting flow of gas, and a flow regulating effect can be stably exhibited.

After the above, when a flow rate of gas becomes small, the lid body 41 rotates by its own weight and hence, the valve unit 40 is brought into a closed state (see FIG. 7), so that the manifold portion 31 corresponding to the energy storage device 20 for which a valve is opened is closed. This makes it difficult for gas in an exhaust path to flow into the gas release valve 29. For this reason, it is possible to further prevent the energy storage device 20 from being excessively heated after gas is discharged.

### Effect and the Like

As described above, according to the energy storage apparatus 1 according to the present embodiment, on the lid body 41 of a single-hinged type which closes the manifold portion 31, the flow regulating portion 42 which extends in a direction intersecting a direction from the base end portion 413 toward the open end portion 414 is provided on the lower surface 419 (main surface). For this reason, flow of gas from the base end portion 413 toward the open end portion 414 can be regulated by the flow regulating portion 42. Specifically, when the lid body 41 is opened by gas discharged from the gas release valve 29, a part of the gas flows along the lower surface 419 of the lid body 41 and reaches the flow regulating portion 42. Since flow of gas can be regulated by the flow regulating portion 42, it is possible to prevent gas from being caught in a direction opposite to a direction in which the gas is desired to be exhausted. By the above, it is possible to cause gas to smoothly flow in a direction in which the gas is desired to be exhausted, and it is possible to prevent a combustible substance, a high-temperature object, and the like which may be discharged together with the gas from coming into contact with another one of the energy storage devices 20. Accordingly, if high-temperature gas is discharged from the energy storage device 20, an adverse effect on another one of the energy storage devices 20 can be prevented.

Further, in the flow regulating portion 42, since a surface (the upper surface 422) exposed to gas is a curved surface projecting toward the lid body 41 and another surface (the lower surface 423) exposed to gas is a curved surface projecting toward the gas release valve 29, gas can be regulated with a smooth curved surface, and a flow regulating effect can be further enhanced. When a flow regulating effect is enhanced, it is possible to further prevent a combustible substance, a high-temperature object, and the like from coming into contact with another one of the energy storage devices 20, and it is possible to further prevent an adverse effect on another one of the energy storage devices 20.

Further, for example, when there is a corner portion in the flow regulating portion 42, there is a high possibility that gas is disturbed. However, when one end portion and another end portion of the flow regulating portion 42 have a tapered shape as in the present embodiment, the one end portion and the another end portion can be formed in a streamlined shape. For this reason, it is possible to make it difficult to generate a turbulent flow in flow of gas, and it is possible to further enhance a flow regulating effect. When a flow regulating effect is enhanced, it is possible to more reliably prevent a combustible substance, a high-temperature object, and the like from coming into contact with another energy storage device, and thus, it is possible to further prevent an adverse effect on another one of the energy storage devices 20.

Further, since the flow regulating portion 42 is arranged at a predetermined interval with respect to the lid body 41, a part of gas flows also within the interval. In gas flowing through this interval, a flow regulating effect of the flow regulating portion 42 can be more reliably exhibited, so that flow regulation of gas can be stabilized.

Further, since the flow regulating portion 42 is rotatably supported by the lid body 41, a posture of the flow regulating portion 42 can be displaced along flow of gas by being rotated. By the above, the flow regulating portion 42 can be prevented from inhibiting flow of gas, and a flow regulating effect can be stably exhibited.

Further, since the base end portion 413 of the lid body 41 is rotatably supported by the manifold portion 31, opening operation and closing operation of the lid body 41 can be smoothly performed. For example, since the manifold portion 31 can be closed by the lid body after gas is discharged, gas in an exhaust path hardly flows into the gas release valve 29 that is opened. For this reason, it is possible to further prevent the energy storage device 20 from being excessively heated after gas is discharged.

### Description of Modification Example

Hereinafter, each modification example of the above embodiment will be described. In description below, the same portions as those in the above embodiment or another modification example are denoted by the same reference signs, and may be omitted from description.

### First Modification Example

In the above embodiment, the case where the flow regulating portion 42 is arranged at a predetermined interval with respect to the lid body 41 is exemplified. In this first modification example, a valve unit in which a flow regulating portion is directly provided on a lid body will be described.

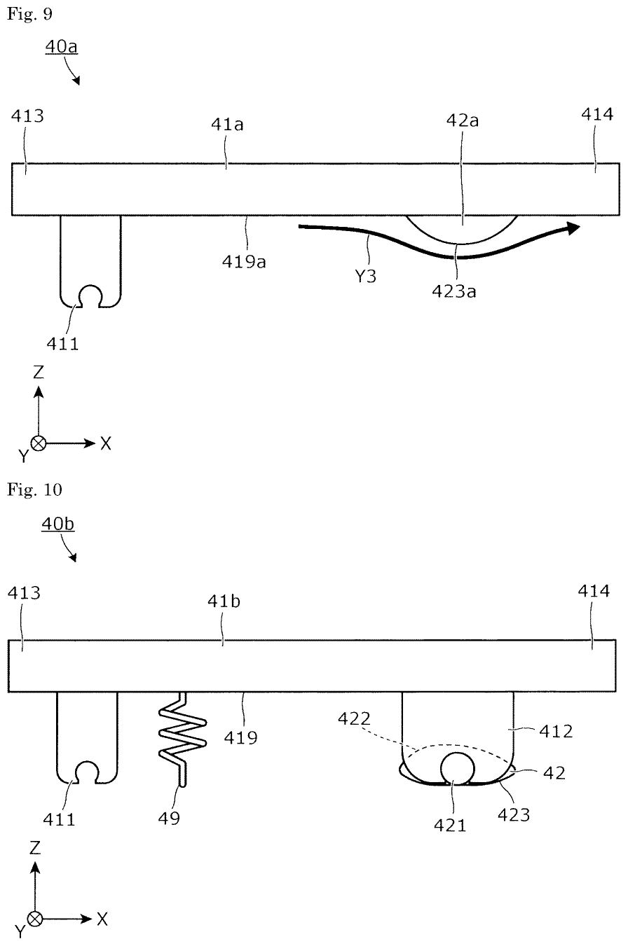

FIG. 9 is a side view of a valve unit 40a according to the first modification example as viewed from the Y-axis minus direction. FIG. 9 is a diagram corresponding to FIG. 7. As illustrated in FIG. 9, in the valve unit 40a, a flow regulating portion 42a having a projecting shape is directly provided on a lower surface 419a of a lid body 41a. A lower surface 423a of the flow regulating portion 42a is a smooth curved surface projecting downward as viewed in the Y-axis direction. When the lid body 41a is opened by gas discharged from the gas release valve 29, the gas flows along the lower surface 419a of the lid body 41a and reaches the flow regulating portion 42a. Since flow of gas (arrow Y3) is regulated on the lower surface 423a of the flow regulating portion 42a, it is possible to prevent gas from being caught in a direction opposite to a direction in which the gas is desired to be exhausted. By the above, it is possible to cause gas to smoothly flow in a direction in which the gas is desired to be exhausted, and it is possible to prevent a combustible substance, a high-temperature object, and the like which may be discharged together with the gas from coming into contact with another one of the energy storage devices 20.

### Second Modification Example

In the above embodiment, the case where the lid body 41 rotates by its own weight and the valve unit 40 enters a closed state when a flow rate of gas becomes small is exemplified. In this second modification example, a valve unit having a biasing portion for actively closing a lid body will be described.

FIG. 10 is a side view of a valve unit 40b according to the second modification example as viewed from the Y-axis minus direction. FIG. 10 is a diagram corresponding to FIG. 7. As illustrated in FIG. 10, an elastic body as a biasing portion is attached to the lid body 41b of the valve unit 40b. Specifically, the elastic body is a spring 49 whose one end portion is fixed to the lid body 41b and another end portion is fixed to the manifold portion 31. The spring 49 biases the lid body 41b toward the gas release valve 29. When gas is discharged from the gas release valve 29, the lid body 41b rotates against biasing force of the spring 49 to cause the valve unit 40b to enter an open state. After the above, when a flow rate of gas becomes small, the lid body 41b rotates by biasing force of the spring 49, and the valve unit 40b enters a closed state. By the above, the valve unit 40b can be more reliably caused to enter a closed state after gas is discharged. Therefore, after gas is discharged, gas in an exhaust path hardly flows into the gas release valve 29, and it is possible to more reliably prevent the energy storage device 20 from being excessively heated.

### Others

Although the energy storage apparatus according to the embodiment of the present invention is described above, the present invention is not limited to the embodiment. That is, the embodiment disclosed herein is illustrative in all respects and is not restrictive, and the scope of the present invention includes all changes within the meaning and scope equivalent to the claims.

For example, in the above-described embodiment, the case where the upper surface 422 of the flow regulating portion 42 is a curved surface projecting toward the lid body 41 and the lower surface 423 is a curved surface projecting toward the gas release valve 29 is exemplified. However, the configuration may be such that at least one of the upper surface and the lower surface of the flow regulating portion is a curved surface.

In the above embodiment, the case where both one end portion and another end portion of the flow regulating portion 42 have a tapered shape is exemplified. However, the configuration may be such that at least one of one end portion and another end portion of the flow regulating portion 42 has a tapered shape.

In the above embodiment, the case where the flow regulating portion 42 is rotatably supported by the lid body 41 is exemplified, but the flow regulating portion may be supported by the lid body so as not to rotate.

In the above embodiment, the case where a base end portion of the lid body 41 is rotatably supported by the manifold portion 31 is exemplified, but the lid body may be supported by the manifold portion so as to be displaced from a closed state to an open state and not to be displaced from an open state to a closed state.

Further, a mode constructed by optionally combining constituent elements included in the above embodiment is also included in the scope of the present invention.

### INDUSTRIAL APPLICABILITY

The present invention can be applied to an energy storage apparatus including an energy storage device such as a lithium ion secondary battery.

### DESCRIPTION OF REFERENCE SIGNS

1: energy storage apparatus
17: bus bar frame
18: opening and closing unit
20: energy storage device
21: case
29: gas release valve
30: support plate
31: manifold portion
32: shaft body
33: bus bar
34: beam portion
40, 40a, 40b: valve unit
41, 41a, 41b: lid body
42, 42a: flow regulating portion
49: spring
71: exhaust portion
76: exhaust path
121: exhaust port
210: case body
411: first bearing
412: second bearing
413: base end portion
414: open end portion
419, 419a: lower surface (main surface)
421: shaft portion
422: upper surface
423, 423a: lower surface

1. An energy storage apparatus comprising:
a plurality of energy storage devices each of which includes a gas release valve and which are arranged in a posture in which the gas release valves face a same direction;
an exhaust portion arranged on the gas release valve of each of a plurality of the energy storage devices and forming an exhaust path of gas discharged from the gas release valve;
a plurality of manifold portions causing the gas release valve of each of a plurality of the energy storage devices to communicate with the exhaust path of the exhaust portion; and
a plurality of valve units that close each of a plurality of the manifold portions,
wherein the valve unit includes:
a lid body of a single-hinged type that closes the manifold portion and includes an open end portion and a base end portion which is an end portion on an opposite side to the open end portion, the lid body having open width of the open end portion larger than open width of the base end portion; and
a flow regulating portion that is arranged on a main surface facing the gas release valve of the lid body and extends in a direction intersecting a direction from the base end portion toward the open end portion.

2. The energy storage apparatus according to claim 1, wherein in the flow regulating portion, a surface exposed to gas is a curved surface projecting toward at least one of the lid body and the gas release valve.

3. The energy storage apparatus according to claim 1, wherein at least one of one end portion and another end portion in a direction from the base end portion toward the open end portion has a tapered shape in the flow regulating portion.

4. The energy storage apparatus according to claim 3, wherein the flow regulating portion is arranged at a predetermined interval with respect to the lid body.

5. The energy storage apparatus according to claim 3, wherein the flow regulating portion is rotatably supported by the lid body.

6. The energy storage apparatus according to claim 1, wherein in the lid body, the base end portion is rotatably supported with respect to the manifold portion.
